(19) United States
(12) Patent Application Publication
(10) Pub. No.: US 2025/0208754 A1
(43) Pub. Date: Jun. 26, 2025

(54) ELECTRONIC DEVICE PROVIDING USER INTERFACE AND METHOD FOR PROVIDING USER INTERFACE USING THE SAME

(71) Applicant: SAMSUNG ELECTRONICS CO., LTD., Suwon-si, (KR)

(72) Inventor: Youngchan WOO, Suwon-si (KR)

(73) Assignee: SAMSUNG ELECTRONICS CO., LTD., Suwon-si, (KR)

(21) Appl. No.: 18/958,092

(22) Filed: Nov. 25, 2024

Related U.S. Application Data
(63) Continuation of application No. PCT/KR2024/096622, filed on Nov. 18, 2024.

(30) Foreign Application Priority Data
Dec. 22, 2023 (KR) 10-2023-0189372

(51) Int. Cl. G06F 3/0484

(52) U.S. Cl. CPC G06F 3/0484

(57) ABSTRACT

An electronic device providing a user interface, according to embodiments of the disclosure may comprise memory storing at least one instruction and at least one processor executing the at least one instruction. The at least one processor may perform a communication connection with a user device based on a trigger input, receive user characteristic information in association with the user device, generate a personal setting option applicable based on the user characteristic information, output a first user interface allowing a selection to be made as to whether to apply the personal setting option, and output a second user interface to which the personal setting option is applied, based on an input through which the selection is made to apply the personal setting option.

### CROSS-REFERENCE TO RELATED APPLICATIONS

This application is a continuation application of International Application No. PCT/KR2024/096622 designating the United States, filed on Nov. 18, 2024, in the Korean Intellectual Property Receiving Office, which claims priority from Korean Patent Application No. 10-2023-0189372, filed on Dec. 22, 2023, in the Korean Intellectual Property Office, the disclosures of which are hereby incorporated by reference herein in their entireties.

### BACKGROUND

### Field

Various embodiments of the disclosure relate to an electronic device that provides a user interface based on user characteristic information in association with a user device and a method for providing a user interface using the same.

### Description of Related Art

With the development of digital technology, various types of electronic devices, such as mobile communication terminals, personal digital assistants (PDAs), electronic schedulers, smartphones, tablet personal computers (PCs), and wearable devices, are in wide use. To support and increase functions, hardware parts and/or software parts of electronic devices are continuously being enhanced.

Recently, users utilize one or more electronic devices to enjoy various media and perform productivity tasks. For example, a user may connect two electronic devices wiredly or wirelessly to use them as a dual-screen or use them for their respective uses. Further, a user may multitask different tasks using a personal electronic device and a shared electronic device.

Meanwhile, when the several electronic devices are used, the shared electronic device may not reflect the user's own characteristics and, unlike the personal electronic device, has a limitation in providing a convenient and beneficial user interface to the user. In particular, digitally vulnerable users have difficulty in substantially using a shared electronic device having a different user interface from a personal electronic device.

Therefore, a need exists for technology for providing a convenient and beneficial, customized user interface to digitally vulnerable users using a shared electronic device, such as digital signage or a kiosk.

### SUMMARY

Various embodiments of the disclosure may provide an electronic device that receives user characteristic information from a user device and provides a user interface to which a personal setting option generated based on the user characteristic information is applied and a method for providing a user interface using the same.

An electronic device providing a user interface, according to embodiments of the disclosure may comprise memory to store at least one instruction and at least one processor executing the at least one instruction. The at least one processor may perform a communication connection with a user device based on a trigger input, receive user characteristic information in association with the user device, generate a personal setting option based on the user characteristic information, output a first user interface allowing a selection to be made as to whether to apply the personal setting option, and output a second user interface to which the personal setting option is applied, based on an input through which the selection is made to apply the personal setting option.

In an embodiment, the first user interface may be a preview user interface to which the personal setting option is previously applied.

In an embodiment, the at least one processor may receive the trigger input including a user input to switch a screen-off state to a screen-on state, sense the user device within a predetermined distance based on the trigger input, and perform the communication connection with the user device, based on recognizing the user device.

In an embodiment, the user characteristic information may include at least one of an output setting value of the user device, personal information about a user, and sensing information of the user device.

In an embodiment, the at least one processor may adjust an output setting value among the user characteristic information based on a characteristic of the electronic device, and generate the personal setting option based on the adjusted output setting value.

In an embodiment, the user device may be a first user device and the at least one processor may receive first user characteristic information from the first user device, receive second user characteristic information from a second user device, calculate a first weight of the first user characteristic information based on a function similarity of the first user device, calculate a second weight of the second user characteristic information based on the function similarity of the second user device, and generate the personal setting option based on the first weight and the second weight.

In an embodiment, the at least one processor may change the personal setting option based on a user input to change the personal setting option in the first user interface.

In an embodiment, the at least one processor may change the personal setting option, based on a user input for changing the user characteristic information in the user device.

In an embodiment, the first user interface may include at least one of an image output interface to which the personal setting option is applied and a voice output interface to which the personal setting option is applied.

In an embodiment, the at least one processor may search for a similar device connected to the user device, receive similar device characteristic information from the similar device, and generate the personal setting option applicable to the user interface based on the user characteristic information and the similar device characteristic information.

In an embodiment, the at least one processor may determine an output mode based on the user characteristic information, and output the first user interface to which the preset personal setting option is applied for each output mode.

In an embodiment, the at least one processor may transmit the personal setting option to at least one external device connected through a network. The at least one external device may output a third user interface to which the personal setting option is applied.

In an embodiment, the at least one processor may determine a driving mode based on the user characteristic information, output the first user interface allowing a selection to be made as to whether to apply the driving mode, and apply the driving mode based on an input through which the selection is made to apply the driving mode.

A method for providing a user interface, according to embodiments of the disclosure may comprise performing a communication connection with a user device based on a trigger input, receiving user characteristic information in association with the user device, generating a personal setting option based on the user characteristic information, outputting a first user interface allowing a selection to be made as to whether to apply the personal setting option, and outputting a second user interface to which the personal setting option is applied, based on an input through which the selection is made to apply the personal setting option.

In an embodiment, the first user interface may be a preview user interface to which the personal setting option is previously applied.

In an embodiment, performing the communication connection with the user device may include receiving the trigger input including a user input for switching a screen-off state to a screen-on state, sensing the user device within a predetermined distance based on the trigger input, and performing the communication connection with the user device, based on recognizing the user device.

In an embodiment, the user characteristic information may include at least one of an output setting value of the user device, personal information about a user, and sensing information of the user device.

In an embodiment, generating the personal setting option applicable to the user interface may include adjusting an output setting value among the user characteristic information based on a characteristic of the electronic device, and generating the personal setting option based on the adjusted output setting value.

In an embodiment, the user device may be a first user device and generating the personal setting option applicable to the user interface may include receiving first user characteristic information from the first user device, receiving second user characteristic information from a second user device, calculating a first weight of the first user characteristic information based on a function similarity of the first user device, calculating a second weight of the second user characteristic information based on the function similarity of the second user device, and generating the personal setting option based on the first weight and the second weight.

In an embodiment, the first user interface may include at least one of an image output interface to which the personal setting option is applied and a voice output interface to which the personal setting option is applied.

According to various embodiments of the disclosure, an electronic device providing a user interface according to the disclosure and a method for providing a user interface using the same may receive user characteristic information from a user device and output a customized user interface to which a personal setting option generated based on the user characteristic information is applied.

Further, the electronic device and the method for providing a user interface using the same according to the disclosure may output a preview user interface to which a personal setting option is pre-applied when selecting whether to apply a customized user interface.

Therefore, the electronic device providing a user interface and a method for providing a user interface using the same according to the disclosure may effectively aid digitally vulnerable users in selecting a user interface using the preview user interface. Further, the electronic device providing a user interface and a method for providing a user interface using the same according to the disclosure may provide various user customized user interfaces based on user characteristic information, thereby increasing user convenience of shared devices.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device in a network environment according to an embodiment;

FIG. 2 illustrates an electronic device and a user device connected to the electronic device according to an embodiment;

FIG. 3 illustrates an operation sequence of an electronic device according to an embodiment;

FIG. 4 illustrates a change in an electronic device according to a trigger input according to an embodiment;

FIG. 5 illustrates an operation of receiving user characteristic information by an electronic device, according to an embodiment;

FIG. 6 illustrates an operation of generating a personal setting option based on user characteristic information by an electronic device, according to an embodiment;

FIG. 7A illustrates an example of a first user interface for selecting whether to apply a personal setting option;

FIG. 7B illustrates another example of a first user interface for selecting whether to apply a personal setting option;

FIG. 8 illustrates a second user interface of an electronic device according to an embodiment;

FIG. 9 illustrates another operation sequence of an electronic device according to an embodiment;

FIG. 10 illustrates an operation of receiving user characteristic information and similar device characteristic information by an electronic device, according to an embodiment;

FIG. 11 illustrates another operation sequence of an electronic device according to an embodiment;

FIG. 12A illustrates an operation of determining an output mode by an electronic device according to an embodiment;

FIG. 12B illustrates an example of a first user interface for selecting whether to apply a personal setting option;

FIG. 12C illustrates a second user interface of an electronic device according to an embodiment;

FIG. 13 illustrates another operation sequence of an electronic device according to an embodiment;

FIG. 14 illustrates an electronic device and an external device according to an embodiment;

FIG. 15 illustrates another operation sequence of an electronic device according to an embodiment;

FIG. 16A illustrates an operation of generating a personal setting option based on user characteristic information and determining a driving mode by an electronic device, according to an embodiment;

FIG. 16B illustrates a second user interface of an electronic device according to an embodiment;

FIG. 17 illustrates an electronic device and a service server connected to the electronic device using a user device, according to an embodiment; and

FIG. 18 illustrates an operation sequence of an electronic device according to an embodiment.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

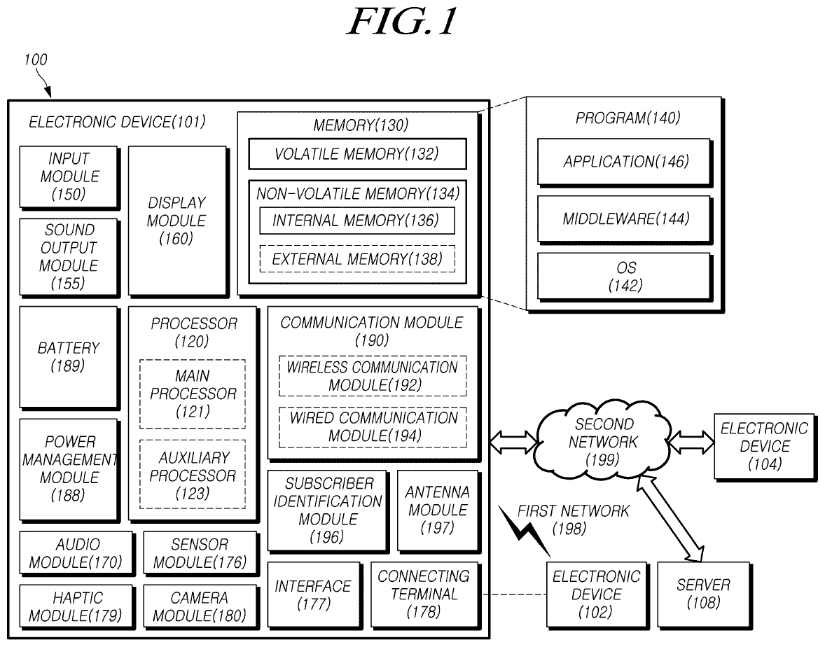

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

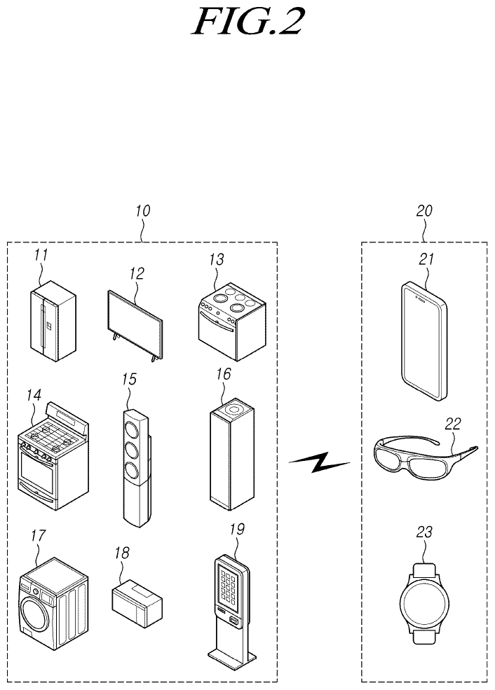

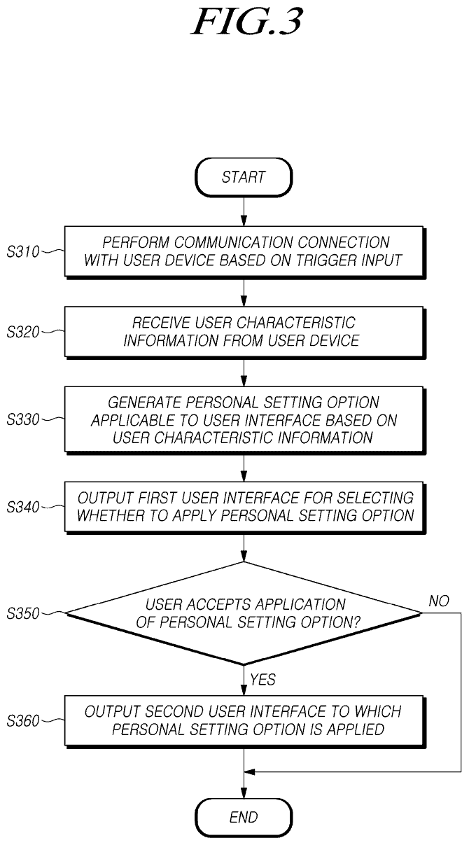

FIG. 2 illustrates an electronic device and a user device connected to the electronic device according to an embodiment, and FIG. 3 illustrates an operation sequence of an electronic device according to an embodiment.

Referring to FIG. 2, an electronic device 10 of the disclosure may be connected to at least one user device 20. The electronic device 10 may include a communication module capable of communicating with the user device 20, a display receiving a user input or outputting information to a user, at least one processor controlling an operation of the electronic device 10, and at least one memory storing a program for controlling an operation of the electronic device 10. For example, the electronic device 10 may receive user characteristic information from the at least one user device 20 and output a user interface based on the user characteristic information. For example, the electronic device 10 may be a shared device shared by a plurality of users.

The electronic device 10 may be various types of shared devices. For example, the electronic device 10 may be a shared device that a user uses when needed, rather than being carried all the time. The electronic device 10 may be at least one of a home appliance including a display panel and an office device. For example, as illustrated in FIG. 2, the electronic device 10 may include at least one of a refrigerator 11, a television 12, an electric range 13, an electric oven 14, an air conditioner 15, a clothing care device 16, a washing machine 17, a microwave oven 18, and a kiosk 19. As another example, the electronic device 10 may include various types of electronic products such as a robot vacuum, a vacuum cleaner, a dishwasher, a multifunction printer, and a printer, which are not illustrated in FIG. 2. However, the above-described electronic products are merely an example of the electronic device 10 of the disclosure, and in addition to the above-described electronic products, a device that may be connected to the user device 20 and perform an operation described below may be included in the electronic device 10 according to an embodiment.

The user device 20 may be various types of personal devices. For example, the user device 20 may be a personal device that the user constantly carries and uses. The user device 20 may include a personal computer, a terminal, a mobile phone, a smart phone, a handheld device, and a wearable device. For example, as illustrated in FIG. 2, the user device 20 may include at least one of a smartphone 21, a smart glass 22, and a smart watch 23. As another example, the user device 20 may include various types of electronic products such as a notebook computer, a tablet PC, and a smart ring, which are not illustrated in FIG. 2. However, the above-described electronic products are merely an example of the user device 20 of the disclosure, and in addition to the above-described electronic products, a device that may be connected to the electronic device 10 and perform an operation described below may be included in the user device 20 according to an embodiment.

Referring to FIG. 3, the electronic device 10 may receive user characteristic information from the user device 20 and provide a user interface to which a personal setting option generated based on the user characteristic information is applied.

Specifically, the electronic device 10 may perform communication connection with the user device 20 based on a trigger input (operation 310), receive user characteristic information from the user device 20 (operation 320), generate a personal setting option applicable to the user interface based on the user characteristic information (operation 330), output a first user interface for selecting whether to apply the personal setting option (operation 340), determine whether the user accepts the personal setting option (operation 350), and based on an input of accepting the application of the personal setting option, output a second user interface to which the personal setting option is applied (operation 360).

According to an embodiment, in operation 310, the electronic device 10 may perform communication connection with the user device 20 based on a trigger input. For example, the trigger input may include a user input for switching a screen-off state of the electronic device 10 to a screen-on state. For example, the electronic device 10 may sense the user device 20 present within a predetermined distance according to the trigger input. The electronic device 10 may perform communication connection with the user device 20 based on recognition of the user device 20. For example, the electronic device 10 may perform communication connection with the user device 20 using short-range wireless communication.

According to an embodiment, in operation 320, the electronic device 10 may receive user characteristic information from the user device 20. For example, the user characteristic information may include at least one of an output setting value of the user device 20, personal information about the user, and sensing information of the user device 20. The output setting value of the user device 20 may include at least one of a text setting value, a display setting value, a sound setting value, and a touch sensitivity setting value. The user's personal information may include at least one of the user's age, gender, body information, and disability information. The sensing information of the user device 20 may include a movement speed of the user, a direction and a posture of the user, and ambient environment information.

According to an embodiment, in operation 330, the electronic device 10 may generate a personal setting option applicable to the user interface based on the user characteristic information. The personal setting option may include user characteristic information. The personal setting option may include an output setting value applicable to the user interface of the electronic device 10 among the user characteristic information. For example, the electronic device 10 may adjust the output setting value corresponding to a characteristic of the electronic device 10 among the user characteristic information based on the characteristic of the electronic device 10, and may generate the personal setting option based on the adjusted output setting value.

According to an embodiment, in operation 340, the electronic device 10 may output a first user interface for selecting whether to apply the personal setting option. For example, the first user interface may be at least one of an image output interface and a voice output interface including the output setting value included in the personal setting option. The first user interface may be a preview user interface to which the personal setting option is previously applied.

According to an embodiment, in operations 350 and 360, the electronic device 10 may determine whether the user accepts the application of the personal setting option, and may output a second user interface to which the personal setting option is applied, based on the input of accepting the application of the personal setting option. For example, the user may determine whether to apply the personal setting option on the first user interface. The electronic device 10 may apply the personal setting option generated from the user characteristic information to the entire user interface based on the application acceptance input of the personal setting option. For example, the second user interface may be a user interface optimized for the user based on at least one of the output setting value of the user device 20, personal information about the user, and sensing information of the user device 20.

As described above, the electronic device 10 providing the user interface according to the disclosure may receive the user characteristic information from the user device 20 and output a customized user interface to which the personal setting option generated based on the user characteristic information is applied. Accordingly, the electronic device 10 providing the user interface according to the disclosure may provide various user-customized user interfaces based on the user characteristic information, thereby increasing the convenience of use of the shared device.

Further, when selecting whether to apply the customized user interface, the electronic device 10 providing the user interface according to the disclosure may output a preview user interface to which the personal setting option is previously applied. Accordingly, the electronic device 10 providing the user interface according to the disclosure may effectively assist digitally vulnerable users in selecting the user interface using the preview user interface.

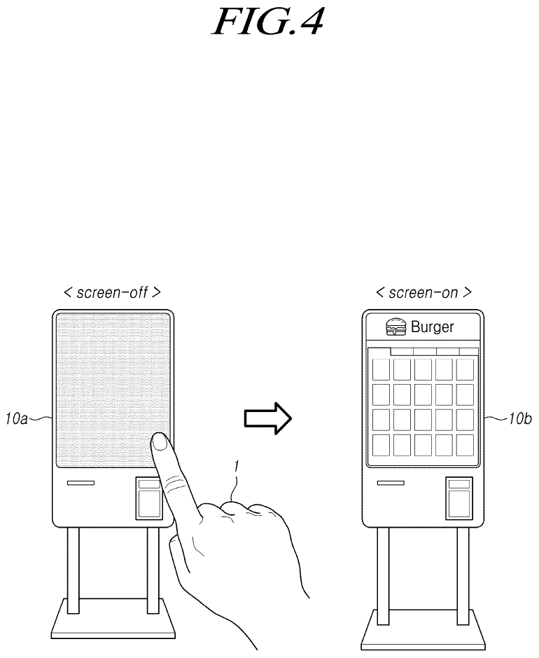

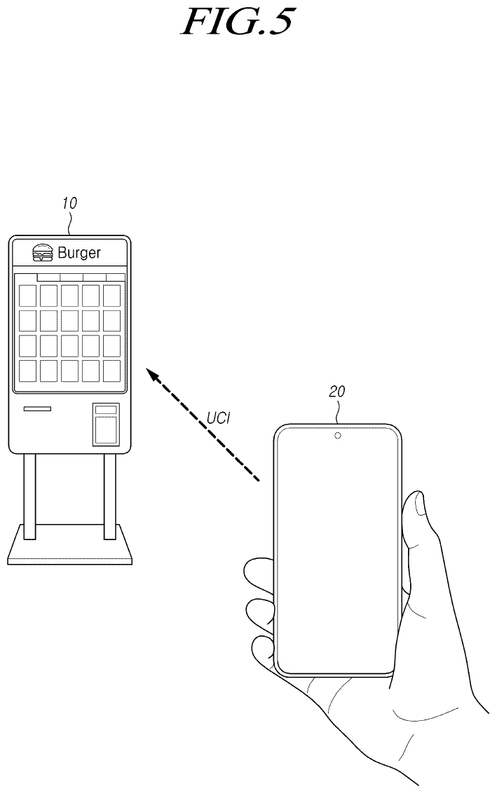

FIG. 4 illustrates a change in an electronic device according to a trigger input according to an embodiment, and FIG. 5 illustrates an operation of receiving user characteristic information UCI by an electronic device according to an embodiment.

Referring to FIGS. 4 and 5, the electronic device 10 may perform communication connection with the user device 20 based on a trigger input and may receive user characteristic information UCI from the user device 20.

The electronic device 10 may receive a trigger input. The trigger input may include various input signals for recognizing the approach of the user device 20. The trigger input may include a user input for switching a screen-off state of the electronic device 10 to a screen-on state.

For example, the trigger input may include at least one of a touch input signal of the user, a voice input signal of the user, a motion input signal of the user, a sensing signal detected by a proximity sensor, or a wired connection signal with the user device 20. For example, as illustrated in FIG. 4, the trigger input may be a touch input of the user's hand 1 to the display screen of the electronic device 10a in the screen-off state. The electronic device 10b may receive the trigger input and may switch to the screen-on state. For example, the trigger input may be a sensing signal generated based on the user's approach by a proximity sensor including at least one of a LiDAR, a D2D network, a laser sensor, and a radar sensor. For example, the trigger input may be an input signal received from a separate control device (e.g., a remote control) possessed by the user.

The electronic device 10 may determine that the user has approached according to the trigger input. The electronic device 10 may sense the user device 20 within a predetermined distance, based on the trigger input, and recognize the user device 20. For example, the electronic device 10 may sense the user device 20 present within a predetermined distance according to the trigger input. The electronic device 10 may perform communication connection with the user device 20 based on recognition of the user device 20.

For example, the electronic device 10 may perform communication connection with the user device 20 using short-range wireless communication. The short-range wireless communication may include, but is not limited to, Bluetooth™ (IEEE 802.15.1), Zigbee (IEEE 802.15.4), wi-fi direct, ultra-wide band (UWB), near-field communication (NFC), and Z-wave.

As shown in FIG. 5, the electronic device 10 may receive user characteristic information UCI from the user device 20. For example, the electronic device 10 may scan the user characteristic information UCI stored in the user device 20 using short-range wireless communication. The user characteristic information UCI may include at least one of an output setting value of the user device 20, personal information about the user, and sensing information of the user device 20.

The output setting value of the user device 20 may include at least one of a text setting value, a display setting value, a sound setting value, and a touch sensitivity setting value.

For example, the text setting value may include a font setting and a text setting of the user interface. Specifically, the text setting value may include at least one of a font style, a font size, and a text highlighting method of the user interface.

For example, the display setting value may include a screen size setting, a screen direction setting, a screen brightness setting, and a screen color setting of the user interface. Specifically, the display setting value may include at least one of resolution adjustment, screen layout, vertical/horizontal mode, screen brightness level, color temperature, color contrast, and black-and-white mode of the user interface.

For example, the sound setting value may include at least one of a volume, a ringtone, and a notification sound of the user interface. For example, the sound setting value may include at least one of text-to-speech (TTS) and voice feedback (e.g., talkback).

In an embodiment, the output setting value may include various setting values based on the function of the user device 20. For example, when the user device 20 is a smartphone (e.g., the smartphone 21 of FIG. 2), the output setting value may include at least one of a talkback setting, a voice support setting, a visibility setting, a hearing aid setting, and an input/action setting.

The talkback setting may be a screen reader function provided in a situation where vision is weak or it is difficult to view the screen. For example, when the talkback setting is used, the user may grasp the content and use the function without looking at the screen based on at least one of the voice feedback of reading the content of the screen and a gesture for quickly executing the function.

The voice support setting may include at least one of keyboard input reading, screen commentary, Bixby vision accessibility, and voice label. For example, keyboard input reading may be a function of reading letters input to the keyboard by voice. For example, the screen commentary may automatically provide an audio description when viewing a video including an audio description. For example, Bixby vision accessibility may be a function in which Bixby vision explains image data collected using a lens of a smartphone. For example, the voice label may provide information about an object within a predetermined distance using an NFC tag.

The visibility setting may include at least one of a screen mode, a high-contrast theme, a high-contrast character, a high-contrast keyboard, button emphasis, color correction, image adjustment, color filter, animation deletion, transparency and blur reduction, screen dimming, screen enlargement, surrounding object magnifying glass, mouse pointer enlargement, font size, font style, and accessibility setting.

The hearing aid setting may include at least one of voice subtitle conversion, real-time subtitle, subtitle setting, sound detection, hearing aid support, ambient sound enhancement, sound quality optimization, all sound off, mono audio, left and right sound balance, and light notification.

The input/operation setting may include at least one of switch control, sub menu, voice access, call answering/disconnecting, touch setting, touch response time, mouse/keyboard setting, fixed key, repeating key input prevention, and input control. For example, the switch control may be a function of controlling the operation of the smartphone based on data collected using the lens of the smartphone. For example, the input control may be a function of limiting an input for a predetermined time.

The user's personal information may include at least one of the user's age, gender, body information, and disability information. For example, the user's personal information may include the user's height, weight, and medical characteristics. For example, the user's personal information may include at least one of whether the user has a visual impairment, whether the user has a hearing impairment, or whether the user has a mobility impairment.

The sensing information of the user device 20 may include a movement speed of the user, a direction and a posture of the user, and ambient environment information. For example, the sensing information of the user device 20 may include the movement speed sensed from the current activity of the user and the past activity. For example, the sensing information of the user device 20 may include the direction and posture of the user sensed from the current activity of the user and the past activity. For example, ambient environment information including at least one of light intensity, temperature, and humidity around the user of the user device 20 may be included.

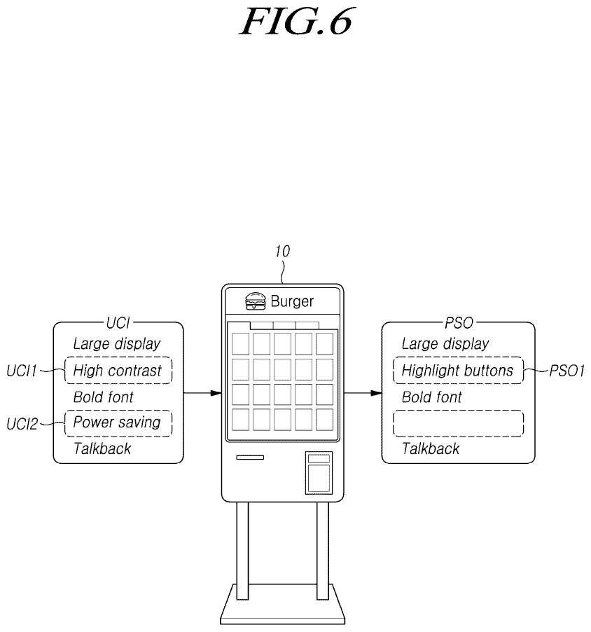

FIG. 6 illustrates an operation of generating a personal setting option PSO based on user characteristic information UCI, according to an embodiment.

Referring to FIG. 6, the electronic device 10 may generate a personal setting option PSO applicable to the user interface based on the user characteristic information UCI. For example, the electronic device 10 may adjust the output setting value corresponding to the characteristic of the electronic device 10 among the user characteristic information UCI based on the characteristic of the electronic device 10, and may generate the personal setting option PSO based on the adjusted output setting value.

The electronic device 10 may adjust the output setting value included in the user characteristic information UCI based on the output function of the electronic device 10 and the display information. In other words, the electronic device 10 may adjust the user characteristic information UCI to be suitable for the electronic device 10. For example, the electronic device 10 may maintain, change, or remove the output setting value based on the output function and display information about the electronic device 10. For example, based on the output function and the display information, the electronic device 10 may maintain the output setting value (e.g., large display, bold font, talkback) that is equally applicable to the user interface among the user characteristic information UCI as the same personal setting option PSO in the electronic device 10. For example, the electronic device 10 may change the output setting value (e.g., high contrast (UCI1)) similarly applicable to the user interface among the user characteristic information UCI to the corresponding personal setting option PSO in the electronic device 10, based on the output function and the display information. For example, the electronic device 10 may remove an inapplicable output setting value (e.g., power saving (UCI2)) among the user characteristic information UCI from the personal setting option PSO based on the output function and the display information.

Specifically, the personal setting option PSO may include user characteristic information UCI. The personal setting option PSO may include the output setting value applicable to the user interface of the electronic device 10 among the user characteristic information UCI. For example, the personal setting option PSO may include the same output setting value as the user characteristic information UCI (e.g., large display, bold font, talkback). For example, the personal setting option PSO may include an output setting value (e.g., highlight buttons PSO1) adjusted from the user characteristic information UCI (e.g., high contrast). For example, the personal setting option PSO may exclude the output setting value (e.g., power saving) of at least a portion of the user characteristic information UCI. The electronic device 10 may output a user interface based on the personal setting option PSO.

In an embodiment, the personal setting option PSO may include various setting options based on the function of the electronic device 10.

For example, when the electronic device 20 is a refrigerator (e.g., the refrigerator 11 of FIG. 2), the personal setting option PSO may include at least one of a screen reader, TTS, font size, gray scale, color inversion, accessibility sound UX, text-to-speech conversion, screen commentary, door opening notification, side navigation, easy handle, and Bixby control.

For example, when the electronic device 20 is a television (e.g., the television 12 of FIG. 2), the personal setting option PSO may include at least one of voice guidance setting, screen commentary, screen enlargement, high contrast screen, focus enlargement, black and white mode, color inversion, color adjustment, remote control learning, menu learning, subtitle setting, sign language setting, sound multiple output, and remote control setting.

For example, when the electronic device 20 is an electric oven (e.g., the electric oven 14 of FIG. 2), the personal setting option PSO may include a cooking mode memory function. For example, the cooking mode storage function may be a function of storing a cooking mode frequently used by the user and displaying the cooking mode at the top of the user interface.

For example, when the electronic device 20 is a washing machine (e.g., the washing machine 17 of FIG. 2), the personal setting option PSO may include at least one of a Braille reference point function, a visibility enhancement screen, and a washing mode memory function. For example, the Braille reference point function may be a function of providing a Braille reference point for the visually impaired so that they may easily grasp the position of an input button of a main function.

In an embodiment, the electronic device 10 may receive user characteristic information UCI from a plurality of user devices 20. For example, the electronic device 10 may perform communication connection with a plurality of surrounding user devices 20 and receive user characteristic information UCI from each of the plurality of user devices 20. In this case, the electronic device 10 may generate a personal setting option PSO by reflecting the weight to the user characteristic information UCI received from the plurality of user devices 20.

Specifically, the electronic device 10 may receive the first user characteristic information UCI from a first user device 20. The electronic device 10 may receive the second user characteristic information UCI from a second user device 20. The electronic device 10 may calculate the weight of the user characteristic information UCI based on the degree to which the first user device 20 and the second user device 20 are similar to the electronic device 10. The electronic device 10 may calculate a function similarity between the first user device 20 and the second user device 20 based on the output function and the display information. For example, the electronic device 10 may calculate a first weight of first user characteristic information based on the functional similarity of the first user device 20. For example, the electronic device 10 may calculate a first weight of first user characteristic information based on the functional similarity of the first user device 20. The electronic device 10 may generate the personal setting option PSO including first user characteristic information and second user characteristic information, based on the first weight and the second weight.

For example, the electronic device 10 may compare the sizes of the displays of the first user device 20 and the second user device 20, and generate the personal setting option PSO including the user characteristic information UCI of the user device 20 having a more similar display size of the first user device 20 and the second user device 20.

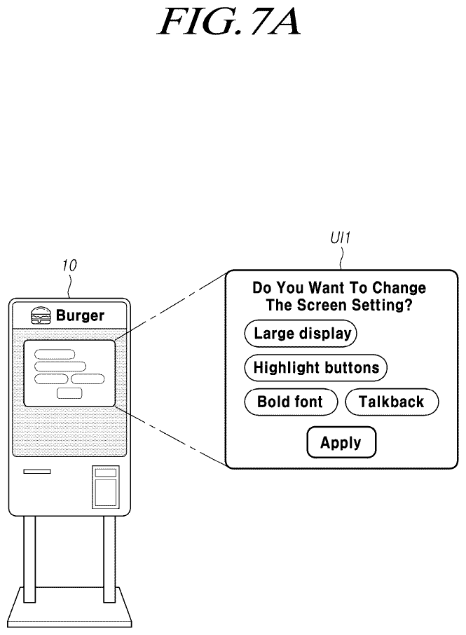

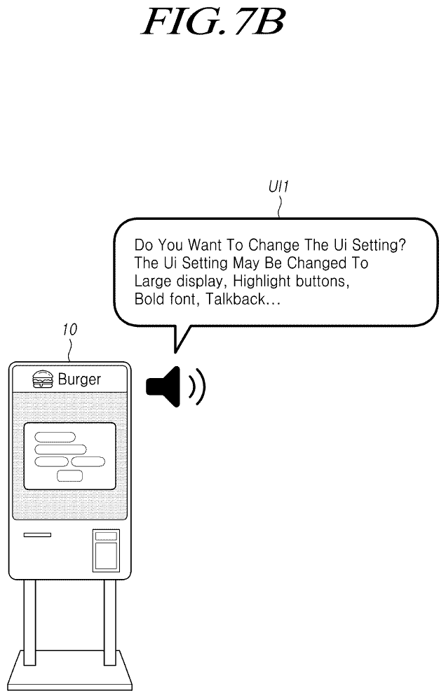

FIG. 7A illustrates an example of a first user interface for selecting whether to apply a personal setting option PSO, and FIG. 7B illustrates another example of a first user interface for selecting whether to apply a personal setting option PSO.

The electronic device 10 may output a first user interface UI1 for selecting whether to apply the personal setting option PSO. The first user interface UI1 may be a preview user interface to which the personal setting option PSO is previously applied. For example, the electronic device 10 may pre-apply and output the personal setting option PSO to the first user interface UI1 for selecting whether to apply the personal setting option PSO. The user may experience the user interface to which the personal setting option PSO is applied in advance through the first user interface UI1 to which the personal setting option PSO is applied. Further, the user may easily recognize the user interface of the electronic device 10 through the first user interface UI1 to which the personal setting option PSO is applied.

Referring to FIGS. 6 and 7A, the electronic device 10 may output an image-based first user interface UI1. The first user interface UI1 may include an image output interface to which the personal setting option PSO is applied. For example, the personal setting option PSO may include large display, highlight buttons, bold font, and talkback. The first user interface UI1 may include an image to which the personal setting option PSO is pre-applied. For example, the electronic device 10 may output an image-based first user interface UI1 to which a personal setting option PSO (e.g., large display, highlight buttons, and bold font) is applied, based on the user characteristic information UCI. The electronic device 10 may receive whether to accept the application of the personal setting option PSO from the user on the first user interface UI1. As described above, the user may experience the user interface to which the personal setting option PSO is applied in advance through the first user interface UI1 to which the personal setting option PSO is applied.

Referring to FIGS. 6 and 7B, the electronic device 10 may output a voice-based first user interface UI1. The first user interface UI1 may include a voice output interface to which the personal setting option PSO is applied. For example, the personal setting option PSO may include large display, highlight buttons, bold font, and talkback. The first user interface UI1 may include a voice to which the personal setting option PSO is pre-applied. For example, the electronic device 10 may output the voice-based first user interface UI1 to which the personal setting option PSO (e.g., talkback) is applied, based on the user characteristic information UCI. The electronic device 10 may receive whether to accept the application of the personal setting option PSO from the user on the first user interface UI1. As such, the user (e.g., the visually impaired) may easily recognize the user interface of the electronic device 10 through the first user interface UI1 to which the personal setting option PSO is applied.

In an embodiment, the electronic device 10 may change the personal setting option PSO. For example, the electronic device 10 may change the personal setting option PSO in the first user interface UI1, based on the user input for changing the personal setting option PSO. In this case, the user may change the personal setting option PSO by selecting the personal setting option PSO in the first user interface UI1. For example, the electronic device 10 may change the personal setting option PSO based on the user input for changing the user characteristic information UCI in the user device 20. In this case, the user may change the personal setting option PSO of the electronic device 10 by changing the user characteristic in the user device 20.

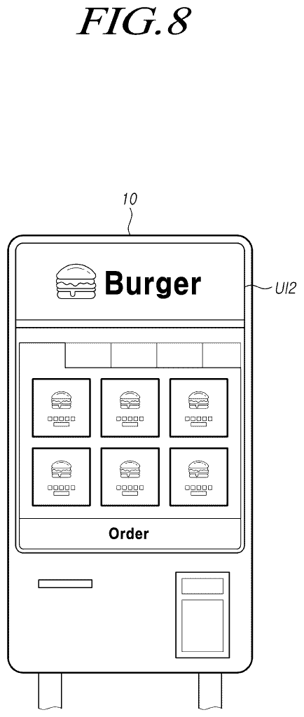

FIG. 8 illustrates a second user interface UI2 of an electronic device according to an embodiment.

Referring to FIG. 8, a second user interface UI2 to which the personal setting option PSO is applied may be output. For example, the second user interface UI2 may be a user interface optimized for the user based on at least one of an output setting value of the user device 20, personal information about the user, and sensing information of the user device 20. For example, the electronic device 10 may apply the personal setting option PSO generated from the user characteristic information UCI to the entire user interface based on the application acceptance input of the personal setting option PSO.

For example, as illustrated in FIGS. 6 and 8, the electronic device 10 may output a second user interface UI2 to which a personal setting option PSO (e.g., large display, highlight buttons, bold font, talkback) generated based on user characteristic information UCI is applied. For example, the second user interface UI2 may have an image enlarged and a selection button and letters emphasized as compared with the user interface before the personal setting option PSO is applied, and provide a talkback function.

As described above, the electronic device 10 providing the user interface according to the disclosure may provide various user-customized user interfaces based on the user characteristic information UCI, thereby increasing the convenience of use of the shared device.

Further, the electronic device 10 providing the user interface according to the disclosure may effectively assist digitally vulnerable users in selecting the user interface using the preview user interface.

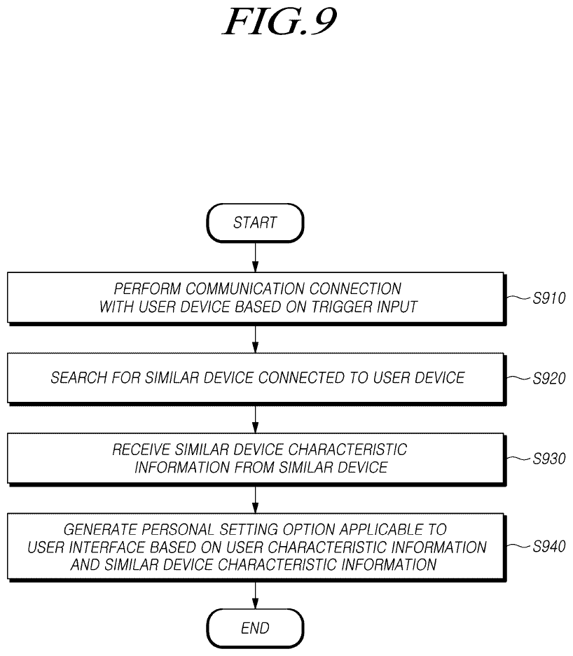

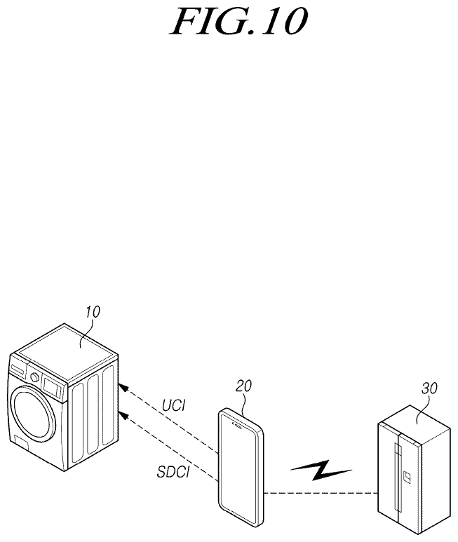

FIG. 9 illustrates a partial operation sequence of an electronic device according to an embodiment, and FIG. 10 illustrates an operation of receiving user characteristic information UCI and similar device characteristic information by an electronic device according to an embodiment.

Referring to FIGS. 9 and 10, the electronic device 10 may perform communication connection with the user device 20 based on a trigger input (operation 910), may search for a similar device 30 connected to the user device 20 (operation 920), may receive similar device characteristic information SDCI from the similar device 30 (operation 930), and may generate a personal setting option PSO applicable to the user interface based on the user characteristic information UCI and the similar device characteristic information SDCI (operation 940).

According to an embodiment, in operation 910, the electronic device 10 may perform communication connection with the user device 20 based on a trigger input. For example, the trigger input may include the user input for switching the screen-off state of the electronic device 10 to the screen-on state. For example, the electronic device 10 may sense the user device 20 present within a predetermined distance according to the trigger input. The electronic device 10 may perform communication connection with the user device 20 based on recognition of the user device 20. For example, the electronic device 10 may perform communication connection with the user device 20 using short-range wireless communication.

According to an embodiment, in operation 920, the electronic device 10 may search for the similar device 30 connected to the user device 20. For example, the electronic device 10 may receive list data of the similar device 30 connected to the user device 20 from the user device 20. The similar device 30 may be an external device connected to the user device 20. For example, like the electronic device 10, the similar device 30 may be at least one of a home appliance including a display panel and an office device. For example, the similar device 30 may include at least one of a refrigerator, a dishwasher, an electric range, an electric oven, an air conditioner, a clothing care device, a washing machine, a microwave oven, or a kiosk. Further, the similar device 30 may include various types of electronic products such as a robot vacuum, a vacuum cleaner, a television, a multifunction printer, and a printer.

According to an embodiment, in operation 930, the electronic device 10 may receive the similar device characteristic information SDCI from the similar device 30. For example, the similar device characteristic information SDCI may include at least one of a text setting value, a display setting value, a sound setting value, and a touch sensitivity setting value of the similar device 30. For example, the electronic device 10 may receive the similar device characteristic information SDCI from the similar device 30 connected to the user device 20 through the user device 20. For example, the electronic device 10 may perform communication connection with the similar device 30 and receive the similar device characteristic information SDCI directly from the similar device 30. Since the output function and the display information about the similar device 30 are similar to those of the electronic device 10, the similar device characteristic information SDCI may include an output setting value suitable for the user interface of the electronic device 10.

According to an embodiment, in operation 940, the electronic device 10 may generate the personal setting option PSO applicable to the user interface based on the user characteristic information UCI and the similar device characteristic information SDCI. The personal setting option PSO may include user characteristic information UCI and similar device characteristic information SDCI. The personal setting option PSO may include an output setting value applicable to the user interface of the electronic device 10 among the user characteristic information UCI and the similar device characteristic information SDCI. For example, the electronic device 10 may adjust the output setting value corresponding to the characteristic of the electronic device 10 among the user characteristic information UCI and the similar device characteristic information (SDCI) based on the characteristic of the electronic device 10, and may generate the personal setting option PSO based on the adjusted output setting value.

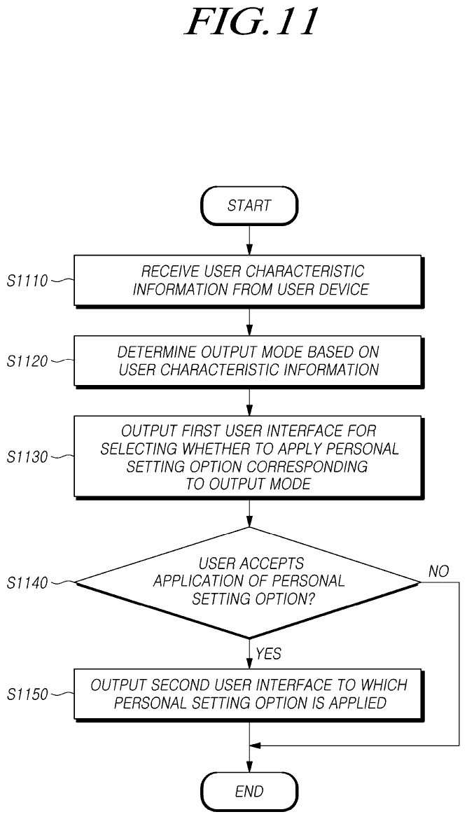

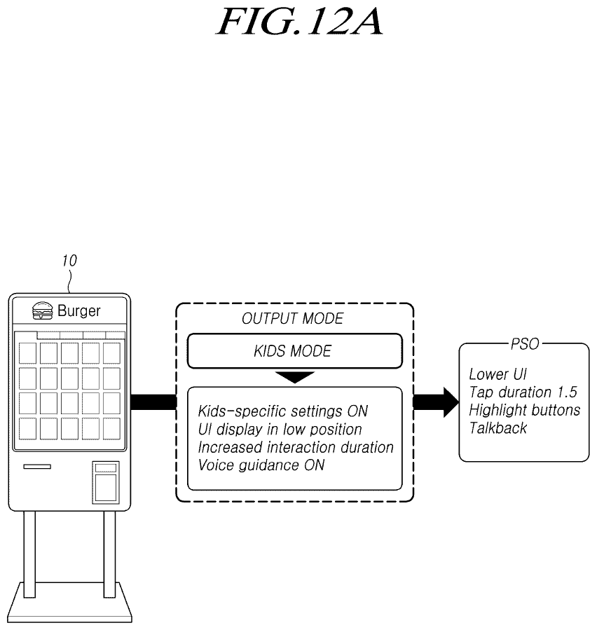

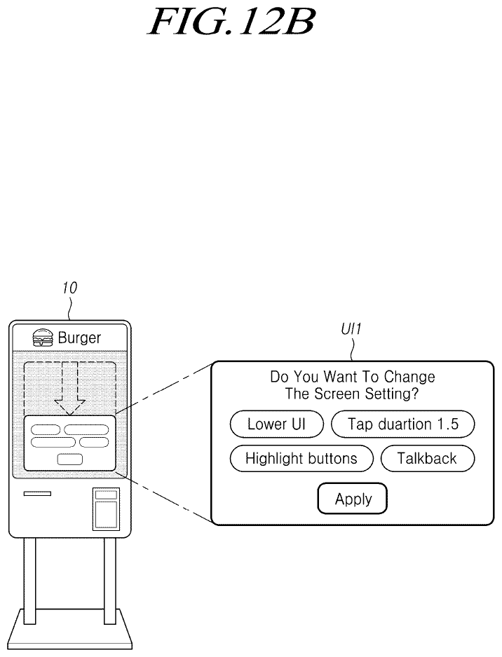

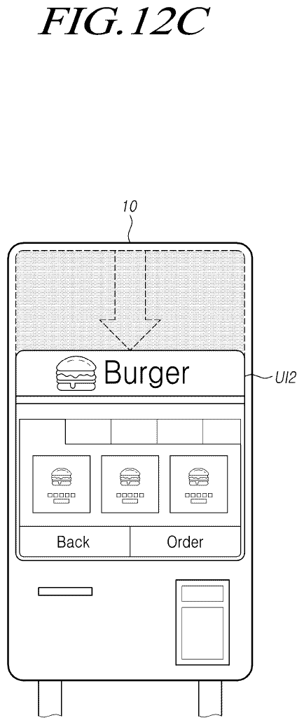

FIG. 11 illustrates another operation sequence of an electronic device according to an embodiment, FIG. 12A illustrates an operation of determining an output mode by an electronic device according to an embodiment, FIG. 12B illustrates an example of a first user interface for selecting whether to apply a personal setting option PSO, and FIG. 12C illustrates a second user interface of an electronic device according to an embodiment.

Referring to FIGS. 11 to 12C, the electronic device 10 may receive user characteristic information UCI from the user device 20 (operation 1110), determine an output mode based on the user characteristic information UCI (operation 1120), output a first user interface UI1 for selecting whether to apply a personal setting option PSO corresponding to the output mode (operation 1130), determine whether the user accepts the personal setting option PSO (operation 1140), and output a second user interface UI2 to which the personal setting option PSO is applied based on an application acceptance input of the personal setting option PSO (operation 1150).

According to an embodiment, in operation 1110, the electronic device 10 may receive the user characteristic information UCI from the user device 20. For example, the user characteristic information UCI may include at least one of an output setting value of the user device 20, personal information about the user, and sensing information of the user device 20. The output setting value of the user device 20 may include at least one of a text setting value, a display setting value, a sound setting value, and a touch sensitivity setting value. The user's personal information may include at least one of the user's age, gender, body information, and disability information. The sensing information of the user device 20 may include a movement speed of the user, a direction and a posture of the user, and ambient environment information.

According to one example, in operation 1120, the electronic device 10 may determine the output mode based on user characteristic information UCI. For example, the electronic device 10 may determine the output mode based on at least one of the output setting value of the user device 20, the personal information about the user, and the sensing information of the user device 20 included in the user characteristic information UCI.

The electronic device 10 may determine the output mode by comparing the similarity between the user characteristic information UCI and the personal setting option PSO preset for each output mode. For example, the electronic device 10 may map the user characteristic information UCI to the personal setting option PSO preset for each output mode. For example, the electronic device 10 may determine whether there is a personal setting option PSO corresponding to the user characteristic information UCI. For example, the electronic device 10 may determine the similarity between the user characteristic information UCI and the personal setting option PSO corresponding to the user characteristic information UCI. For example, the electronic device 10 may compare at least one of the output setting value of the user device 20, personal information about the user, or sensing information of the user device 20 with the personal setting option PSO preset for each output mode, thereby determining similarity. The electronic device 10 may determine the output mode based on the similarity determination result between the user characteristic information UCI and the personal setting option PSO preset for each output mode.

The output mode may be an output mode that provides an optimized user interface to the user of a specific group. For example, the output mode may include at least one of a kids mode, a senior mode, a visually impaired mode, a hearing impaired mode, and a multilingual mode. The electronic device 10 may extract the personal setting option PSO preset for each output mode. For example, at least one memory of the electronic device 10 may store at least one of a kids setting option, a senior setting option, a visually impaired setting option, a hearing impaired setting option, and a multilingual setting option preset for each output mode.

For example, as illustrated in FIG. 12A, the electronic device 10 may determine the output mode as the kids mode based on the user characteristic information UCI. The kids mode may be an output method that provides a user interface optimized for child users. For example, in the kids mode, the electronic device 10 may select age-limited content considering the user's age. For example, in the kids mode, the electronic device 10 may output a low-height user interface considering the height of the user. For example, in the kids mode, the electronic device 10 may increase the interaction duration considering the reaction speed of the user. For example, in the kids mode, the electronic device 10 may provide a voice guidance function considering the user's reading comprehension. In the output mode, the electronic device 10 may extract a preset kids setting option. For example, the kids setting option may include Lower UI, Tap duration 1.5, highlight buttons, and talkback.

According to an embodiment, in operation 1130, the electronic device 10 may output a first user interface UI1 for selecting whether to apply the personal setting option PSO corresponding to the output mode. For example, the electronic device 10 may output the first user interface UI1 to which the preset PSO is applied for each output mode. For example, as illustrated in FIG. 12B, the first user interface UI1 may be a user interface to which the kids setting option (e.g., Lower UI, Tap duration 1.5, highlight buttons, talkback) is applied. For example, the user (e.g., a child) may easily recognize the user interface of the electronic device 10 and experience the user interface in advance through the first user interface UI1 to which the personal setting option PSO (e.g., the kids setting option) is applied.

According to an embodiment, in operations 1140 and 1150, the electronic device 10 may determine whether the user accepts the application of the personal setting option PSO, and may output a second user interface UI2 to which the personal setting option PSO is applied, based on an input for accepting the application of the personal setting option PSO. For example, the user may determine whether to apply the personal setting option PSO on the first user interface UI1. The electronic device 10 may apply the personal setting option PSO generated from the user characteristic information UCI to the entire user interface based on the application acceptance input of the personal setting option PSO.

For example, as illustrated in FIG. 12C, the electronic device 10 may output the second user interface UI2 to which the kids setting option (e.g., Lower UI, Tap duration 1.5, highlight buttons, talkback) extracted based on user characteristic information UCI is applied. For example, the second user interface UI2 may have an image displayed lower than the user interface before the personal setting option PSO is applied, interaction duration increased, selection button and letters emphasized, and may provide a talkback function.

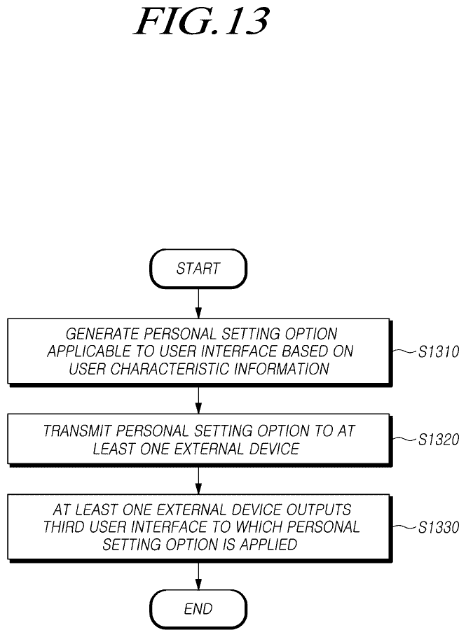

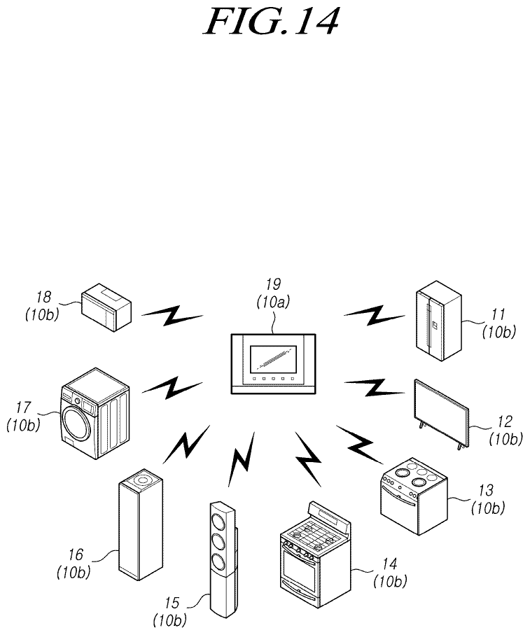

FIG. 13 illustrates another operation sequence of an electronic device according to an embodiment, and FIG. 14 illustrates an electronic device and an external device according to an embodiment.

Referring to FIGS. 13 and 14, the electronic device 10 may generate a personal setting option PSO applicable to the user interface based on the user characteristic information UCI (operation 1310) and may transmit the personal setting option PSO to at least one external device (operation 1320). At least one external device may output (operation 1330) a third user interface to which the personal setting option PSO is applied.

According to an embodiment, in operation 1310, the electronic device 10 may generate the personal setting option PSO applicable to the user interface based on the user characteristic information UCI. The personal setting option PSO may include user characteristic information UCI. The personal setting option PSO may include an output setting value applicable to the user interface of the electronic device 10 among the user characteristic information UCI. For example, the electronic device 10 may adjust the output setting value corresponding to the characteristic of the electronic device 10 among the user characteristic information UCI based on the characteristic of the electronic device 10, and may generate the personal setting option PSO based on the adjusted output setting value.

According to an embodiment, in operation 1320, the electronic device 10 may transmit the personal setting option PSO to at least one external device 10b connected through a network. For example, as illustrated in FIG. 14, the external device 10b may be an electronic product (e.g., the refrigerator 11, the television 12, the electric range 13, the electric oven 14, the air conditioner 15, the clothing care device 16, the washing machine 17, or the microwave oven 18) including a display panel. For example, as illustrated in FIG. 14, the electronic device 10 may be a hub device 10a (e.g., the wall pad 19) connected to at least one external device 10b and controlling the operation of the at least one external device 10b.

The electronic device 10 may be connected to at least one external device through a network. The network may include both a wired network and a wireless network. The wired network may include a cable network, a telephone network, or the like, and the wireless network may include all networks that transmit and receive signals through radio waves. The wired network and the wireless network may be connected to each other.

The electronic device 10 may transmit the personal setting option PSO to at least one external device using the network. The personal setting option PSO may include user characteristic information UCI. The personal setting option PSO may include an output setting value applicable to the user interface of at least one external device among the user characteristic information UCI.

According to an embodiment, in operation 1330, the at least one external device may output a third user interface to which the personal setting option PSO is applied. For example, the at least one external device may output the third user interface to which the personal setting option PSO received from the electronic device 10 is applied. For example, the third user interface may be a user interface optimized for the user based on at least one of an output setting value of the user device 20, personal information about the user, and sensing information of the user device 20.

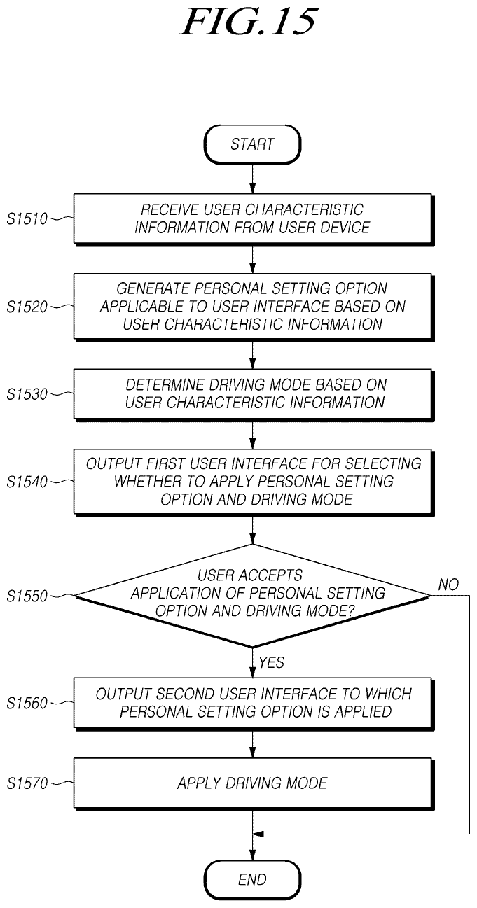

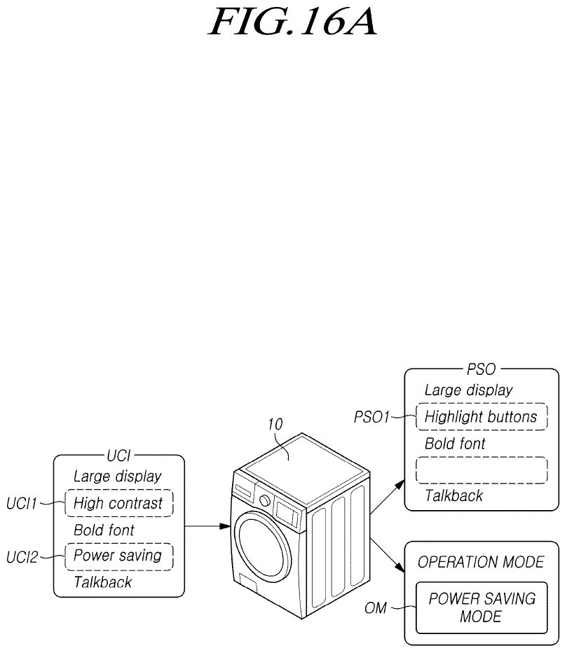

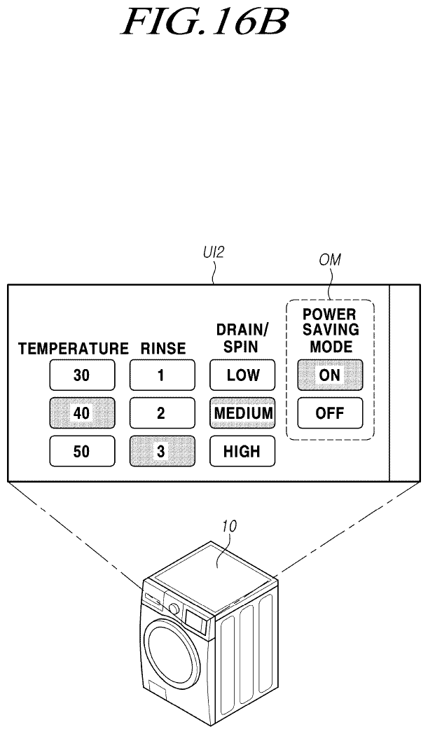

FIG. 15 illustrates another operation sequence of an electronic device according to an embodiment, FIG. 16A illustrates an operation in which the electronic device according to an embodiment generates a personal setting option PSO based on user characteristic information UCI and determines a driving mode, and FIG. 16B illustrates a second user interface UI2 of an electronic device according to an embodiment.

Referring to FIGS. 15 to 16B, the electronic device 10 may receive user characteristic information UCI from the user device 20 (operation 1510), generate a personal setting option PSO applicable to the user interface based on the user characteristic information UCI (operation 1520), determine a driving mode based on the user characteristic information UCI (operation 1530), outputting a first user interface UI1 for selecting whether to apply the personal setting option PSO and the driving mode (operation 1540), determine whether to the user accepts the personal setting option PSO (operation 1550), and apply a second user interface UI2 to which the personal setting option PSO is applied (operation 1560) and apply the driving mode (operation 1570), based on the application acceptance input of the personal setting option PSO.

According to an example, in operation 1510, the electronic device 10 may receive user characteristic information UCI from the user device 20. For example, the user characteristic information UCI may include at least one of an output setting value of the user device 20, personal information about the user, and sensing information of the user device 20. The output setting value of the user device 20 may include at least one of a text setting value, a display setting value, a sound setting value, and a touch sensitivity setting value. The user's personal information may include at least one of the user's age, gender, body information, and disability information. The sensing information of the user device 20 may include a movement speed of the user, a direction and a posture of the user, and ambient environment information.

According to an embodiment, in operation 1520, the electronic device 10 may generate the personal setting option PSO applicable to the user interface based on the user characteristic information UCI. The personal setting option PSO may include user characteristic information UCI. The personal setting option PSO may include an output setting value applicable to the user interface of the electronic device 10 among the user characteristic information UCI. For example, the electronic device 10 may adjust the output setting value corresponding to the characteristic of the electronic device 10 among the user characteristic information UCI based on the characteristic of the electronic device 10, and may generate the personal setting option PSO based on the adjusted output setting value.

For example, as shown in FIG. 16A, the personal setting option PSO may include the same output setting value as the user characteristic information UCI (e.g., large display, bold font, talkback). For example, the personal setting option PSO may include an output setting value PSO1 (e.g., highlight buttons) adjusted from the user characteristic information UCI (e.g., high contrast). For example, the personal setting option PSO may exclude the output setting value (e.g., power saving) of at least a portion of the user characteristic information UCI. The electronic device 10 may output a user interface based on the personal setting option PSO.

According to one example, in operation 1530, the electronic device 10 may determine the driving mode based on user characteristic information UCI.

The driving mode may refer to a scheme for performing the main driving of the electronic device 10. For example, the driving mode may include at least one of a power saving mode, an active mode, a sleep mode, and a safe mode. The power saving mode may be a process of minimizing power consumption of the electronic device 10. For example, the power saving mode may minimize at least one of display brightness, driving intensity, background process, and network activity of the electronic device 10. The active mode may be a process of actively executing main driving of the electronic device 10. For example, the active mode may maximize the driving intensity of the electronic device 10. The sleep mode may be a process of providing an optimal sleep environment to the user. For example, the sleep mode may minimize display brightness and driving noise of the electronic device 10. The safe mode may be a process for protecting the state of the electronic device 10. For example, the safe mode may provide only basic functions of the electronic device 10 and limit additional functions.

The electronic device 10 may determine the driving mode of the electronic device 10 as at least one of the power saving mode, the active mode, the sleep mode, and the safe mode, based on the user characteristic information UCI. For example, the electronic device 10 may determine the driving mode of the electronic device 10 based on at least one of the output setting value of the user device 20, personal information about the user, and sensing information of the user device 20.

For example, as illustrated in FIG. 16A, the electronic device 10 may extract user characteristic information UCI capable of determining the driving mode OM (e.g., the power saving mode) from the output setting value of the user device 20, personal information about the user, and sensing information of the user device 20. The electronic device 10 may perform main driving based on the driving mode OM.

According to an example, in operation 1540, the electronic device 10 may output a first user interface UI1 for selecting whether to apply the personal setting option PSO and the driving mode. For example, the first user interface UI1 may be at least one of an image output interface and a voice output interface including a personal setting option PSO driving mode. The first user interface UI1 may be a preview user interface to which the personal setting option PSO is previously applied.

According to an example, in operation 1550, operation 1560, and operation 1570, the electronic device 10 may output the second user interface UI2 to which the personal setting option PSO is applied and drive the driving mode, based on the application acceptance input of the personal setting option PSO. For example, the user may determine whether to apply the personal setting option PSO on the first user interface UI1. The electronic device 10 may apply the personal setting option PSO generated from the user characteristic information UCI to the entire user interface based on the application acceptance input of the personal setting option PSO. For example, the second user interface UI2 may be a user interface optimized for the user based on at least one of the output setting value of the user device 20, personal information about the user, and sensing information of the user device 20.

As illustrated in FIG. 16B, the electronic device 10 may output a second user interface UI2 to which the personal setting option PSO (e.g., large display, highlight buttons, bold font, talkback) generated based on user characteristic information UCI is applied. For example, the second user interface UI2 may have an image enlarged and a selection button and letters emphasized as compared with the user interface before the personal setting option PSO is applied, and provide a talkback function.

As illustrated in FIG. 16B, the electronic device 10 may apply the driving mode OM (e.g., the power saving mode) determined based on the user characteristic information UCI. For example, when performing main driving, the electronic device 10 may minimize at least one of display brightness, driving intensity, background process, and network activity of the electronic device 10.

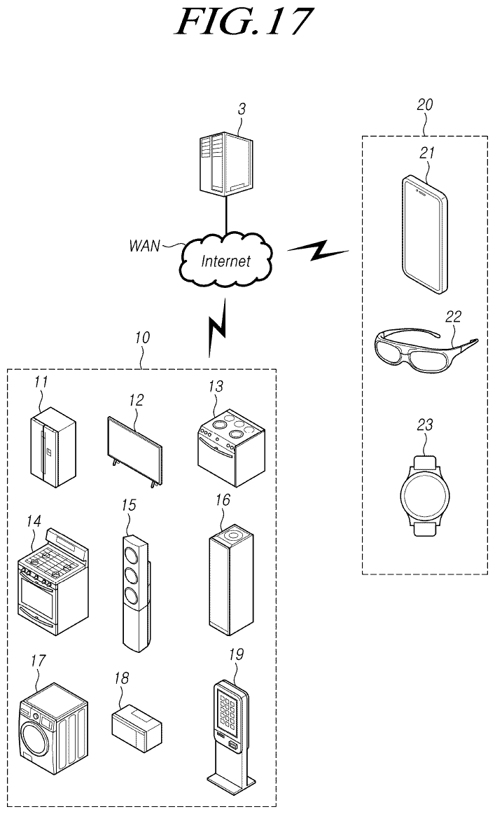

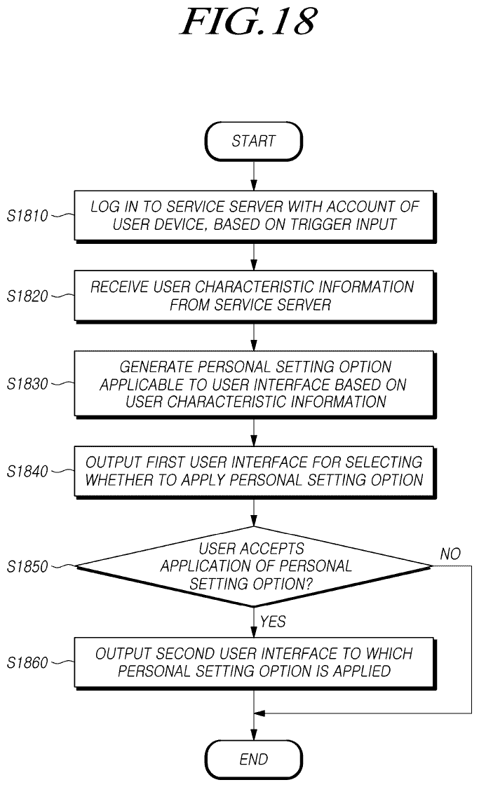

FIG. 17 illustrates an electronic device and a service server connected to the electronic device using a user device according to an embodiment, and FIG. 18 illustrates an operation sequence of an electronic device according to an embodiment.

Referring to FIG. 17, the electronic device 10 according to the disclosure may be connected to at least one user device 20. The electronic device 10 may be connected to at least one service server 3. The electronic device 10 may include a communication module capable of communicating with the user device 20 and the service server 3, a display receiving a user input or outputting information to a user, at least one processor controlling an operation of the electronic device 10, and at least one memory storing a program for controlling an operation of the electronic device 10. For example, the electronic device 10 may receive an account from at least one user device 20. The electronic device 10 may log in to the service server 3 with the account of the user device. The electronic device 10 may receive user characteristic information from the service server 3 and output the user interface based on the user characteristic information. For example, the electronic device 10 may be a shared device shared by a plurality of users.

The electronic device 10 may be various types of shared devices. For example, the electronic device 10 may be a shared device that a user uses when needed, rather than being carried all the time. The electronic device 10 may be at least one of a home appliance including a display panel and an office device. For example, as illustrated in FIG. 2, the electronic device 10 may include at least one of a refrigerator 11, a television 12, an electric range 13, an electric oven 14, an air conditioner 15, a clothing care device 16, a washing machine 17, a microwave oven 18, and a kiosk 19. As another example, the electronic device 10 may include various types of electronic products such as a robot vacuum, a vacuum cleaner, a dishwasher, a multifunction printer, and a printer, which are not illustrated in FIG. 2. However, the above-described electronic products are merely an example of the electronic device 10 of the disclosure, and in addition to the above-described electronic products, a device that may be connected to the user device 20 and perform an operation described below may be included in the electronic device 10 according to an embodiment.

The user device 20 may be various types of personal devices. For example, the user device 20 may be a personal device that the user constantly carries and uses. The user device 20 may include a personal computer, a terminal, a mobile phone, a smart phone, a handheld device, and a wearable device. For example, as illustrated in FIG. 2, the user device 20 may include at least one of a smartphone 21, a smart glass 22, and a smart watch 23. As another example, the user device 20 may include various types of electronic products such as a notebook computer, a tablet PC, and a smart ring, which are not illustrated in FIG. 2. However, the above-described electronic products are merely an example of the user device 20 of the disclosure, and in addition to the above-described electronic products, a device that may be connected to the electronic device 10 and perform an operation described below may be included in the user device 20 according to an embodiment.

The service server 3 may include a communication module capable of communicating with another server, the electronic device 10 or the user device 20, home appliance 10 or the user device 20, at least one processor capable of processing data received from the other server, electronic device 10, or user device 20, and at least one memory capable of storing a program for processing data or processed data. For example, the service server 3 may be implemented as various computing devices such as a workstation, a cloud, a data drive, and a data station. The service server 3 may be implemented as one or more servers physically or logically divided based on functions, detailed configurations of functions, data, or the like, and may transmit and receive data and process the transmitted and received data through communication between the servers.

The service server 3 may manage the account (e.g., the user account). The service server 3 may store or update the user characteristic information, with the user characteristic information associated with the account. For example, the electronic device 10 may receive the account (e.g., the user account) through the user device 20. The account may be identified by an ID and a password set by the user. The electronic device 10 may access the service server 3 and log in to the service server 3 with the account of the user device 20.

In an embodiment, the service server 3 may register the electronic device 10 in the account according to a predetermined procedure. For example, the service server 3 may register, manage, and control the electronic device 10 by connecting identification information (e.g., the serial number or the MAC address) of the electronic device 10 to the account. The service server 3 may transmit the user characteristic information to the electronic device 10 based on the account. For example, the electronic device 10 may receive the user characteristic information stored in association with the account from the service server 3.

The service server 3 may communicate with the electronic device 10 and the user device 20 through a network. Here, the network may include both a wired network and a wireless network. The wired network may include a cable network, a telephone network, or the like, and the wireless network may include all networks that transmit and receive signals through radio waves. The wired network and the wireless network may be connected to each other.

The network may include a wide area network (WAN) such as the Internet, a local area network (LAN) formed around an access point (AP), and a short-range wireless network that does not pass through the AP. The short-range wireless network may include, but is not limited to, Bluetooth™ (IEEE 802.15.1), Zigbee (IEEE 802.15.4), Wi-Fi direct, near-field communication (NFC), and Z-wave.

Referring to FIG. 18, the electronic device 10 may log in to the service server 3 with the account of the user device 20, receive user characteristic information from the service server 3, and provide the user interface to which a personal setting option generated based on the user characteristic information is applied.

Specifically, the electronic device 10 may log in to the service server 3 with the account of the user device 20 based on a trigger input (operation 1810), receive user characteristic information from the service server 3 (operation 1820), generate a personal setting option applicable to the user interface based on the user characteristic information (operation 1830), output a first user interface for selecting whether to apply the personal setting option (operation 1840), determine whether the user accepts the personal setting option (operation 1850), and based on an input of accepting the application of the personal setting option, output a second user interface to which the personal setting option is applied (operation 1860).

According to an example, in operation 1810, the electronic device 10 may log in to the service server 3 with the account (e.g., the user account) of the user device 20 based on the trigger input. For example, the trigger input may include a user input for switching the screen-off state of the electronic device 10 to the screen-on state. For example, the electronic device 10 may sense the user device 20 present within a predetermined distance according to the trigger input. The electronic device 10 may receive the account (e.g., the user account) of the user device 20 based on recognizing the user device 20.

The electronic device 10 may access the service server 3 and log in to the service server 3 with the account of the user device 20. For example, the electronic device 10 may access the service server 3 using at least one of a wide area network (WAN) such as the Internet, a local area network (LAN) formed around an access point (AP), or a short-range wireless network not passing through the access point (AP). For example, the electronic device 10 may log in to the service server 3 with the account of the user device 20 using the at least one network.

According to an example, in operation 1820, the electronic device 10 may receive user characteristic information from the user server 3. The service server 3 may store or update the user characteristic information, with the user characteristic information associated with the account. For example, the service server 3 may store or update the user characteristic information by receiving the user characteristic information from the user device 20 through the at least one network. For example, the user characteristic information may include at least one of an output setting value of the user device 20, personal information about the user, and sensing information of the user device 20. The output setting value of the user device 20 may include at least one of a text setting value, a display setting value, a sound setting value, and a touch sensitivity setting value. The user's personal information may include at least one of the user's age, gender, body information, and disability information. The sensing information of the user device 20 may include a movement speed of the user, a direction and a posture of the user, and ambient environment information.

According to an example, in operation 1830, the electronic device 10 may generate a personal setting option applicable to the user interface based on the user characteristic information. The personal setting option may include user characteristic information. The personal setting option may include an output setting value applicable to the user interface of the electronic device 10 among the user characteristic information. For example, the electronic device 10 may adjust an output setting value corresponding to the characteristic of the electronic device 10 among the user characteristic information based on the characteristic of the electronic device 10, and may generate the personal setting option based on the adjusted output setting value.

According to an embodiment, in operation 1840, the electronic device 10 may output a first user interface for selecting whether to apply the personal setting option. For example, the first user interface may be at least one of an image output interface and a voice output interface including the output setting value included in the personal setting option. The first user interface may be a preview user interface to which the personal setting option is previously applied.

According to an embodiment, in operations 1850 and 1860, the electronic device 10 may determine whether the user accepts the application of the personal setting option, and may output a second user interface to which the personal setting option is applied, based on the input of accepting the application of the personal setting option. For example, the user may determine whether to apply the personal setting option on the first user interface. The electronic device 10 may apply the personal setting option generated from the user characteristic information to the entire user interface based on the application acceptance input of the personal setting option. For example, the second user interface may be a user interface optimized for the user based on at least one of the output setting value of the user device 20, personal information about the user, and sensing information of the user device 20.

According to various embodiments of the disclosure, an electronic device providing a user interface according to the disclosure and a method for providing a user interface using the same may receive user characteristic information from a user device and output a customized user interface to which a personal setting option generated based on the user characteristic information is applied.

Further, the electronic device and the method for providing a user interface using the same according to the disclosure may output a preview user interface to which a personal setting option is pre-applied when selecting whether to apply a customized user interface.

Therefore, the electronic device providing a user interface and a method for providing a user interface using the same according to the disclosure may effectively aid digitally vulnerable users in selecting a user interface using the preview user interface. Further, the electronic device providing a user interface and a method for providing a user interface using the same according to the disclosure may provide various user customized user interfaces based on user characteristic information, thereby increasing user convenience of shared devices. However, since this has been described above, no duplicate description is given.

The display device according to various embodiments of the disclosure may be one of various types of electronic devices. The display devices may include, for example, a portable communication device (e.g., a smartphone), a computer device, a portable multimedia device, a portable medical device, a camera, a wearable device, or a home appliance. The display devices according to an embodiment of the disclosure are not limited to the above-described devices.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if”' may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed:

1. An electronic device providing a user interface, comprising:
a memory to store at least one instruction; and
at least one processor executing the at least one instruction that is stored in the memory, wherein the at least one processor:
performs a communication connection with a user device based on a trigger input;
receives user characteristic information in association with the user device;
generates a personal setting option based on the user characteristic information;
outputs a first user interface allowing a selection to be made as to whether to apply the personal setting option; and
outputs a second user interface to which the personal setting option is applied, based on an input through which the selection is made to apply the personal setting option.

2. The electronic device of claim 1, wherein the first user interface is a preview user interface to which the personal setting option is previously applied.

3. The electronic device of claim 2, wherein the at least one processor:
receives the trigger input including a user input to switch a screen-off state to a screen-on state;
senses the user device within a predetermined distance based on the trigger input; and
performs the communication connection with the user device, based on recognizing the user device.

4. The electronic device of claim 2, wherein the user characteristic information includes at least one of an output setting value of the user device, personal information about a user, and sensing information of the user device.

5. The electronic device of claim 2, wherein the at least one processor:
adjusts an output setting value among the user characteristic information based on a characteristic of the electronic device; and
generates the personal setting option based on the adjusted output setting value.

6. The electronic device of claim 2, wherein the user device is a first user device and the at least one processor:
receives first user characteristic information from the first user device;
receives second user characteristic information from a second user device;
calculates a first weight of the first user characteristic information based on a function similarity of the first user device;
calculates a second weight of the second user characteristic information based on the function similarity of the second user device; and
generates the personal setting option based on the first weight and the second weight.

7. The electronic device of claim 2, wherein the at least one processor changes the personal setting option based on a user input to change the personal setting option in the first user interface.

8. The electronic device of claim 2, wherein the at least one processor changes the personal setting option, based on a user input to change the user characteristic information in the user device.

9. The electronic device of claim 2, wherein the first user interface includes at least one of an image output interface to which the personal setting option is applied and a voice output interface to which the personal setting option is applied.

10. The electronic device of claim 2, wherein the at least one processor:
searches for a similar device connected to the user device;
receives similar device characteristic information from the similar device; and
generates the personal setting option applicable to the user interface based on the user characteristic information and the similar device characteristic information.

11. The electronic device of claim 2, wherein the at least one processor:
determines an output mode based on the user characteristic information; and
outputs the first user interface to which a preset personal setting option is applied for each output mode.

12. The electronic device of claim 2, wherein the at least one processor transmits the personal setting option to at least one external device connected through a network, and
wherein the at least one external device outputs a third user interface to which the personal setting option is applied.

13. The electronic device of claim 2, wherein the at least one processor:
determines a driving mode based on the user characteristic information;
outputs the first user interface allowing a selection to be made as to whether to apply the driving mode; and
applies the driving mode based on an input through which the selection is made to apply the driving mode.

14. A method for providing a user interface, the method comprising:
performing a communication connection with a user device based on a trigger input;
receiving user characteristic information in association with the user device;
generating a personal setting option based on the user characteristic information;
outputting a first user interface allowing a selection to be made as to whether to apply the personal setting option; and
outputting a second user interface to which the personal setting option is applied, based on an input through which the selection is made to apply the personal setting option.

15. The method of claim 14, wherein the first user interface is a preview user interface to which the personal setting option is previously applied.

16. The method of claim 15, wherein performing the communication connection with the user device includes:
receiving the trigger input including a user input for switching a screen-off state to a screen-on state;
sensing the user device within a predetermined distance based on the trigger input; and
performing the communication connection with the user device, based on recognizing the user device.

17. The method of claim 15, wherein the user characteristic information includes at least one of an output setting value of the user device, personal information about a user, and sensing information of the user device.

18. The method of claim 15, wherein the generating of the personal setting option applicable includes:
adjusting an output setting value among the user characteristic information based on a characteristic of the electronic device; and
generating the personal setting option based on the adjusted output setting value.

19. The method of claim 15, wherein the user device is a first user device and generating the personal setting option applicable includes:
receiving first user characteristic information from the first user device;
receiving second user characteristic information from a second user device;
calculating a first weight of the first user characteristic information based on a function similarity of the first user device;
calculating a second weight of the second user characteristic information based on the function similarity of the second user device; and
generating the personal setting option based on the first weight and the second weight.

20. The method of claim 15, wherein the first user interface includes at least one of an image output interface to which the personal setting option is applied and a voice output interface to which the personal setting option is applied.
